(19) United States
(12) Patent Application Publication
(10) Pub. No.: US 2005/0252457 A1
(43) Pub. Date: Nov. 17, 2005

(54) Automated pet food dispenser

(76) Inventors: Michael Keith Morosin, Morro Bay, CA (US); Rose Chan Morosin, Morro Bay, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/845,771

(22) Filed: May 14, 2004

(51) Int. Cl. A01K 5/02

(52) U.S. Cl. 119/51.13

(57) ABSTRACT

An automated pet food dispenser is described that comprises a rotatable food chamber with multiple cavities to hold food for different meals, a base unit for supporting the food chamber, a rotary mechanism to rotate the food chamber relative to the base, and a timing mechanism that indicates feeding times. At feeding times, the rotary mechanism rotates the food chamber to position a selected cavity such that food stored in the cavity may drop out of an opening in the cavity, preferably through a chute or channel, and into a feeding station positioned below. A control unit in the automated pet food dispenser may be configured to initiate anti-jamming procedures if food becomes jammed and obstructs the rotation of the food chamber. In various embodiments, feeding times may be set to occur at fixed time intervals or may be set to occur at times set on a programmable clock on the base unit. In some embodiments, a recording mechanism in the automated pet food dispenser allows a user to record an audio clip such as a voice message, music, or other selected sound for calling a pet to eat at feeding times.

### FIELD OF THE INVENTION

The present invention relates to pet feeders, and, more particularly, to automated pet feeders.

### BACKGROUND OF THE INVENTION

Pet owners who must be away from their pets for an extended duration or whose busy schedule makes regular pet feedings difficult to carry out face a difficult situation. It is not always possible or convenient to arrange to have someone else take over feeding duties for the pet owner, and it is often not an acceptable choice to leave a large quantity of food available to the pet that is sufficient to last the duration of the owner's absence.

Automated pet feeders provide selected quantities of food to a pet at selected feeding times. According to some designs, individual portions of food may be served out in advance into individual receptacles, formed, for example, in a ring, and a cover that covers the receptacles may be rotated in association with a timer mechanism to expose one or more receptacles, thus making the food therein available to the pet. Such feeders may be more difficult to clean than is one bowl and may not be available for cleaning until all portions of food have been eaten or otherwise removed from the feeder. Furthermore, when used indoors, such feeders are typically placed further away from walls in order to allow the pet to have access to all of the receptacles than is a pet dish that holds a single serving. Thus, extra space may inconveniently be taken up by the feeder.

Automated feeders that store portions of food above one or more feeding receptacles and that drop food according to a timed schedule may similarly take up an inconvenient amount of floor space if the dropped food is not guided into a single location.

Another problem faced by automated pet feeders is the problem of jamming. When pieces of pet food obstruct normal operation of an automated feeder, the feeder may become jammed and may be unable to fulfill its function of providing regularly timed feedings to a pet without intervention of a human to oversee operations. For example, a pet who is upset at an owner's absence may not eat or may eat less than is normal, causing dispensed food to build up between feedings and to possibly obstruct normal operation of an automated pet feeder. This situation may become a more frequent occurrence with pet food that comes in large pellets or chunks with rough surfaces, such as dry dog food chunks, which may commonly come in chunks of ¼″-½″ diameter sizes. Pet owners may therefore feel that they cannot rely on the automated pet feeder.

### SUMMARY OF THE INVENTION

An automated pet food dispenser is described that comprises a rotatable food chamber with multiple cavities to hold food for different meals, a base unit for supporting the food chamber, a rotary mechanism to rotate the food chamber relative to the base, and a timing mechanism that indicates feeding times. At feeding times, the rotary mechanism rotates the food chamber to position a selected cavity such that food stored in the cavity may drop out of an opening in the cavity, preferably through a chute or channel, and into a feeding station positioned below. A control unit in the automated pet food dispenser may be configured to initiate anti-jamming procedures if food becomes jammed and obstructs the rotation of the food chamber. In various embodiments, feeding times may be set to occur at fixed time intervals or may be set to occur at times set on a programmable clock on the base unit. In some embodiments, a recording mechanism in the automated pet food dispenser allows a user to record an audio clip such as a voice message, music, or other selected sound for calling a pet to eat at feeding times.

An embodiment of an automated animal food dispenser is described. The automated animal food dispenser comprises: a rotatable chamber with multiple cavities to hold food for different meals; a removable bowl for receiving food dispensed from said chamber; a base unit configured to support said rotatable chamber, said base unit comprising a chute, slide, channel or other guiding mechanism with a top and a bottom that are open and that allow food from a cavity positioned above said chute to be dispensed through the chute into said removable bowl; a rotary mechanism for rotating said rotatable chamber relative to said base unit; a timer configured to provide an indication of a next feeding time; and a control unit configured to receive said indication from said timer and to trigger, based at least in part on said indication, said rotary mechanism to rotate said chamber, allowing a next one of said cavities in said rotatable chamber to dispense food stored therein.

An embodiment of a method for dispensing food for an animal is described that comprises the acts of: outputting a timer signal; running a motor to advance a container of food over an opening in response to receiving said timer signal; and stopping said motor to position said container of food over said opening to permit food in said container to drop through a chute into a feeding dish for dispensing to an animal.

An embodiment of a method for feeding an animal using an automated pet feeder is described. The method comprises the acts of: placing food into one or more cavities in a food chamber of an automated pet feeder; setting a timer on said automated pet feeder to indicate feeding times; placing a receptacle in a position for receiving said food dropped through a chute from one of said cavities; and activating power to said automated pet feeder to cause said feeder to drop said food sequentially from said cavities into a removable bowl.

An embodiment of a pet feeder is described that comprises: plural food chambers having openings which permit food to drop from said chambers; a barrier mechanism which selectively obstructs said openings to prohibit food from dropping from said food chambers; a guide for guiding food dropped from said food chambers; and a timer controlling said barrier mechanism to permit food to drop from selected ones of said food chambers.

An embodiment of a system is described for automatically dispensing pet food. The system comprises: plural storing means for storing quantities of pet food to be dropped at feeding times; timing means for determining feeding times; dispensing means responsive to said timing means for allowing pet food stored in selected ones of said storing means to drop at selected feeding times; and guiding means for guiding dropped pet food into a feeding station.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages taught or suggested herein.

### BRIEF DESCRIPTION OF THE DRAWINGS

These and other features of the invention will now be described with reference to the drawings summarized below. These drawings and the associated description are provided to illustrate preferred embodiments of the inventions, and not to limit the scope of the invention. Like reference characters designate the same or similar parts throughout the several views.

FIG. 1 shows one embodiment of an automated pet food dispenser.

FIG. 2A shows a top view of one embodiment of the automated pet food dispenser, displaying a food chamber with a three cavities for holding pet food.

FIG. 2B shows one embodiment of the automated pet food dispenser, displaying a food chamber with a five cavities for holding pet food.

FIG. 3 shows a cutaway view of one embodiment of the automated pet food dispenser, displaying a chute that allows food to drop from the chamber to the feeding bowl below.

FIG. 4 shows a cutaway view of one embodiment of a base unit.

FIG. 5A is a flow chart that depicts one embodiment of a method for automatically dispensing pet food under normal operation.

FIG. 5B is a flow chart that depicts one embodiment of a method for handling jams that occur while attempting to automatically dispense pet food.

### DETAILED DESCRIPTION OF THE PREFERRED EMBODIMENT

An automated pet food dispenser is described that allows portions of pet food for subsequent feeding to a pet to be placed into cavities in a rotatable food chamber. A base unit that supports the food chamber is configured to rotate the food chamber and to monitor the position of the food chamber relative to a chute or other guiding mechanism in the base unit for dispensing the food. The food chamber is configured to drop food from a cavity that is positioned over the chute.

In various embodiments, different numbers of food cavities may allow for different numbers of automated feedings to occur. Furthermore, a time schedule for automated feeding times may be set by a variety of methods, including specifying a desired time interval between feedings and specifying desired clock times for feedings. Embodiments exist that allow a user to make a sound recording to accompany automated feedings in order to alert a pet to the presence of food and to encourage the pet to eat. Anti-jamming systems and methods in various embodiments allow the automated pet dispenser to overcome obstructions to normal operation without the intervention of a human user.

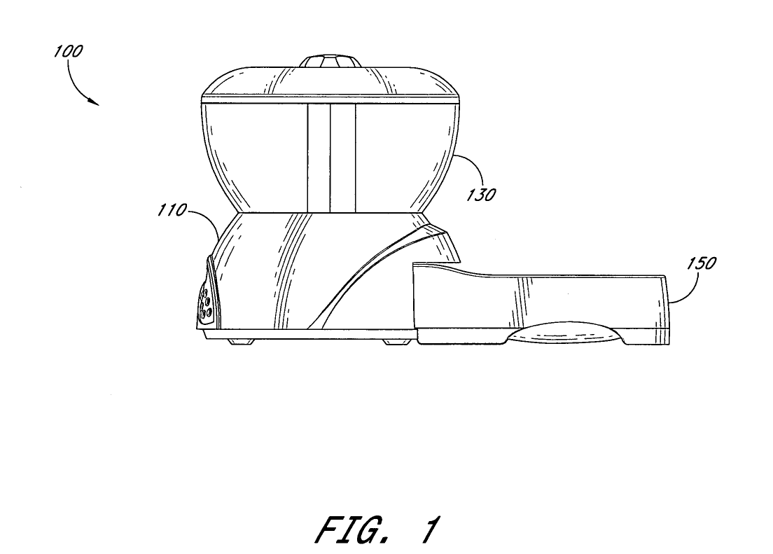

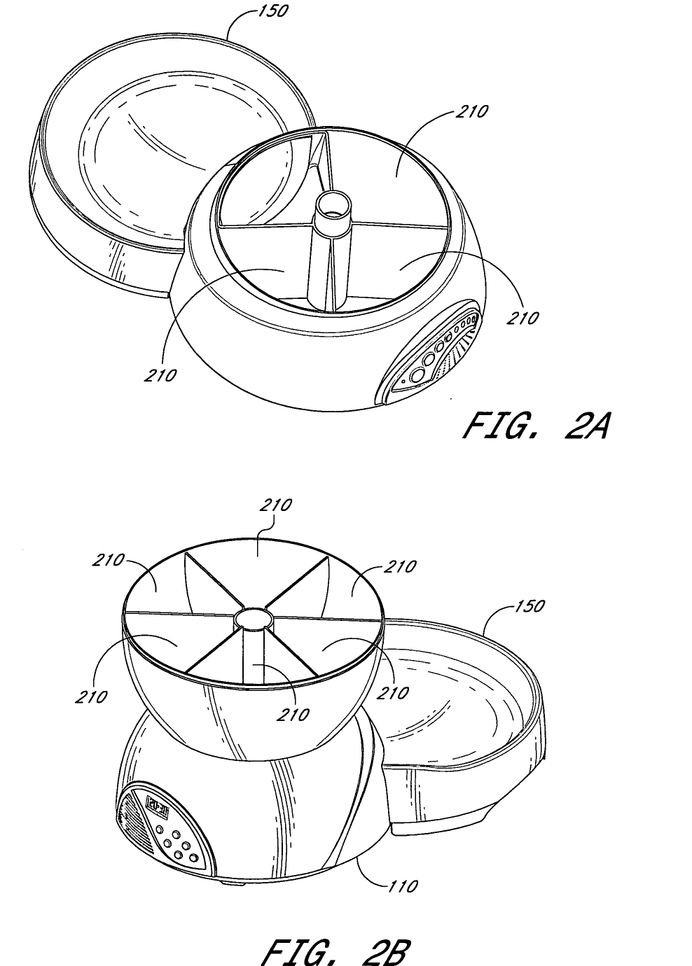

FIG. 1 shows one embodiment of an automated pet food dispenser 100 that comprises a base unit 110, a food chamber 130, and a feeding bowl 150. As is more clearly illustrated in FIGS. 2A and 2B, the food chamber 130 is divided into a plurality of cavities 210 with open bottoms. In some embodiments, the cavities 210 may be approximately 4-5″ deep and 2-3″wide. The food chamber 130 may be seated into the base unit 110 by means of small protrusions at a bottom portion of the food chamber 130 which fit into corresponding slots in the base unit 110, and which, when the food chamber 130 is rotated slightly relative to the base unit 110, detachably lock the food chamber 130 into place atop the base unit. When the food chamber 130 is seated on top of the base unit 110, the upper surface of the base unit 110 obstructs the open bottoms of the cavities 210 so that the cavities 210 may be filled with food. The food chamber 130 comprises a removable lid 134 and a lid lock screw 135, which may be unscrewed to allow the lid 134 to be lifted off the food chamber 130, for example in order to fill it, and may screwed on in order to tighten the lid 134 onto the food chamber 130. When the food chamber 130 is seated atop the base unit 110, pet food or other similar material may be placed into the cavities 210 for dispensing according to an automated schedule.

The food chamber 130 may be made of molded plastic or other suitable material. Using translucent plastic allows food placed inside the cavities 210 of the chamber 130 to be viewed from the outside.

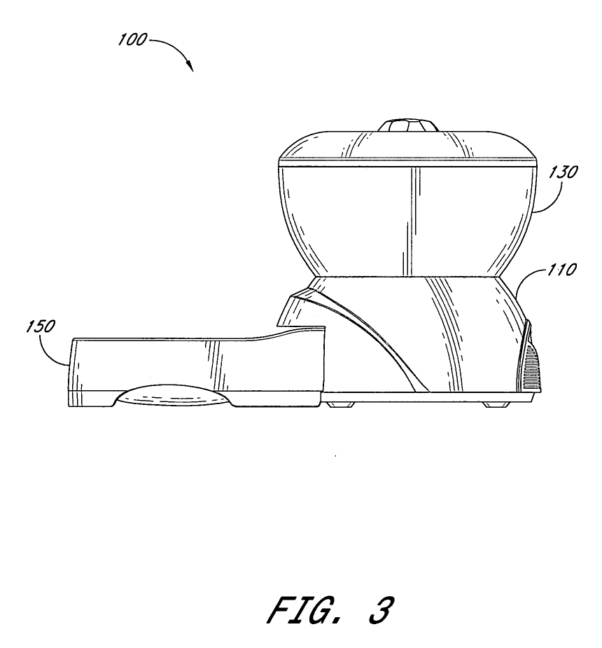

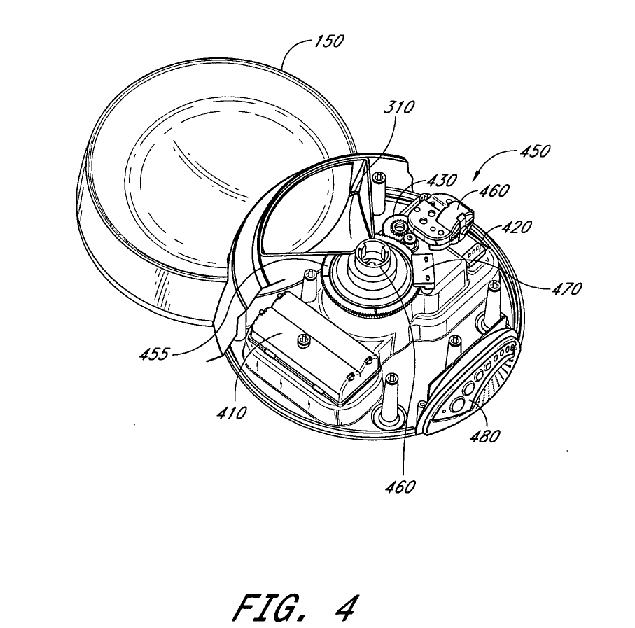

The base unit 110 houses controls and mechanisms that allow for rotation of the food chamber 130 and for performance of other functions of the automated pet food dispenser 100, as will be described in greater detail with reference to FIG. 4. FIG. 3 illustrates a chute 310 in the base unit 110 that is open at the top and bottom. When the feeding bowl 150 is positioned adjacent to the base unit 110 and beneath the chute 310, and when a cavity 210 holding pet food is rotated over the chute 310, food in the cavity 310 may drop through the chute 310 into the feeding bowl 150 below and may thus become available to a pet for eating. In other embodiments, the chute 310 may be a channel, tube, tunnel, slide, pathway, or other guiding mechanism for guiding food dropped from a cavity 210 in a bowl 150 or other feeding station below. The feeding bowl 150 may be shaped to fit snugly against the automated food dispenser 100. In some embodiments, the feeding bowl 150 may form an integral part of the automated food dispenser 100.

FIG. 4 illustrates an inner view of the base unit 110, which comprises a battery cabinet 410 for holding batteries that power the automated pet food dispenser 100 and a power switch 420. The base unit 110 further comprises a main control unit (MCU) 440 that is programmed, in part, to control power to a driving system 450 that drives a chamber driving gear set 430 with one or more reduction gears. The chamber driving gear set 430 in turn drives a ring gear 455 attached to a drive pedestal 460. This pedestal 460 rotatably supports the food chamber 130 (See FIG. 1) and is attached thereto by a releasable latch 465 into which the food chamber 130 may be engaged, thus causing the food chamber 130 to rotate when the gear shaft 420 rotates.

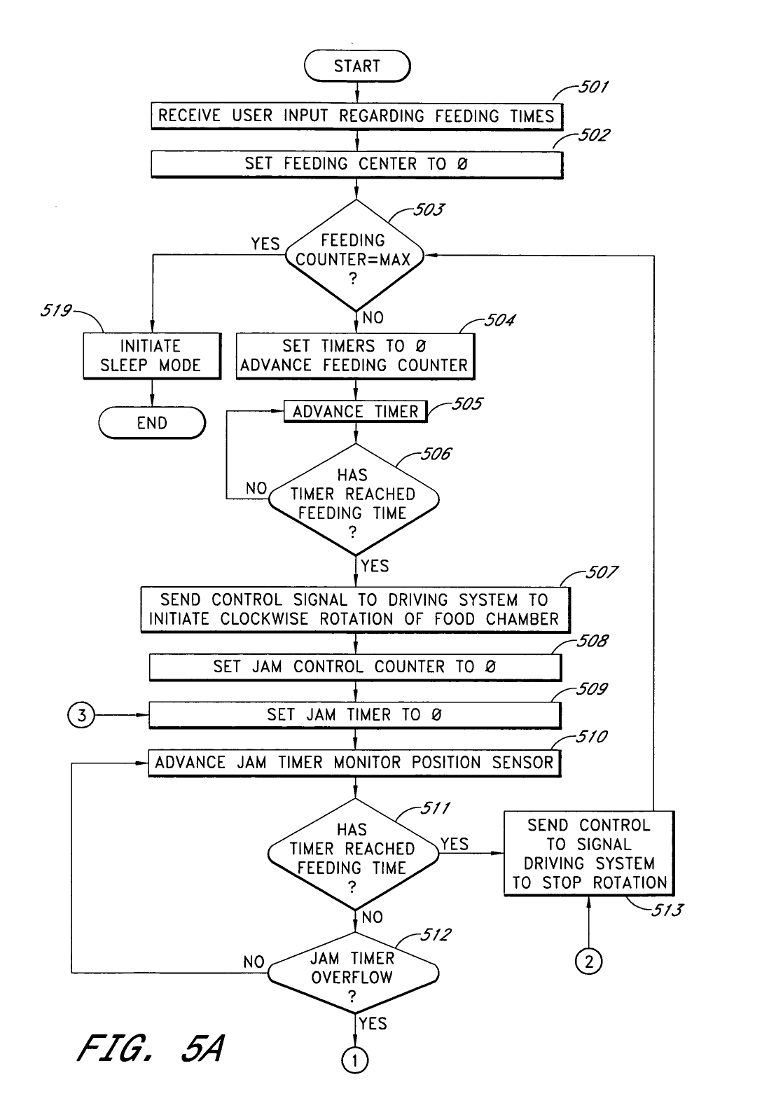

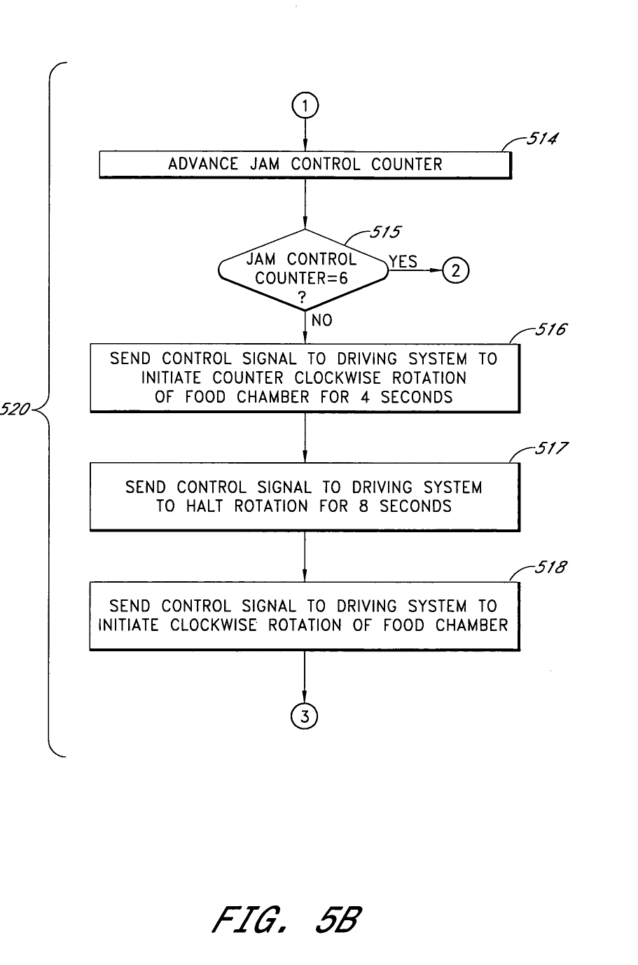

The MCU 440 further controls and monitors one or more position sensors 470. In a preferred embodiment, two optical sensors or photo-couplers 470 are used to determine a precise position of the food chamber 130 and its multiple cavities 210 with reference to the chute 310 or other window for allowing food to drop from a cavity 210 of the food chamber 130 into the feeding bowl 150. Holes in the gear 455 that correspond to the number and placement of cavities 210 in the food chamber 130 allow light to pass through, triggering a photo-coupler reading that may be used by the MCU 440 to determine if the rotating food chamber 130 is properly aligned or if it has become stuck, due, for example, to jammed food. FIGS. 5A and 5B describe in greater detail normal operation of the pet food dispenser 100 as controlled by the MCU 440 as well as an anti-jamming procedure that provides a great advantage to pet owners who want to be assured that the pet food dispenser 100 can reliably deliver food to their pet as scheduled while they are away.

As depicted in FIG. 4, the base unit 110 further comprises a control panel 480. A start/reset button on the control panel 480 allows a user to initiate a new set of feedings. In various embodiments, the control panel 480 allows the user to indicate desired times at which food will be dispensed to the feeding bowl 150. In one embodiment, radio-style buttons on the control panel allow the user to select time intervals of eight, twelve, or twenty-four hours between feedings. In other embodiments, intervals of other lengths may be offered or a numerical keypad may allow users to enter interval lengths of their own choosing. In another type of embodiment, the control panel 480 may comprise an LCD clock that allows a user to set a specific time at which food will be dispensed by the pet food dispenser 100 in much the same way that digital alarm clocks may be set to ring at a given time. In embodiments in which the user sets feeding times with an LCD clock, the control panel 480 may allow the user to set a feeding time for each cavity 210 of food in the food chamber 130. In some embodiments, the control panel 480 may provide opportunity for the user to choose between options to set feeding times using time intervals or using clock time.

The control panel 480 may further comprise a recording mechanism that allows the user to record a voice or other audio recording that is played by the pet food dispenser 100 when food is dispensed. Thus, a pet-owner may record a message to the pet, calling the pet to eat in a manner to which the pet is accustomed, which may encourage and remind the pet to eat while the pet-owner is away. Embodiments that include a recoding mechanism include well-known components such as, for example, a record button for recording an audio clip, a play button for testing the recorded clip, a microphone for receiving the message or other sound for recording, and a speaker to allow the pet to hear the sound.

FIGS. 5A and 5B present one embodiment of a procedure 500 for automatically dispensing pet food using the automated pet food dispenser 100, including procedures for handling jams that may occur.

The procedure 500 begins at a start state when a user presses a start/reset button on the control panel 480. In Block 501 the MCU 440 receives and stores user input regarding desired feeding times. As was described with reference to FIG. 4, according to two contemplated methods, feeding times may be indicated as a desired interval length of time between feedings or as a clock time at which food is to be dispensed. The embodiment depicted in the flowchart of FIGS. 5A and 5B use the time interval method. However, as will be familiar to one of ordinary skill in the art, re-configuring the method 500 to accept feeding time specifications such as clock times may be accomplished without undue experimentation on the part of the practitioner.

Block 502 sets a Feeding Counter to zero, indicating that no feedings have yet been dispensed since the start/reset button was pushed. Block 503 tests to see if the Feeding Counter is yet at a maximum number of feedings available for a given configuration of food chamber 130 and cavities 210. For example, the three food cavities of the embodiment shown in FIG. 2A indicate that a maximum of three feedings may be dispensed from one filling of the food chamber cavities 210, while the embodiment shown in FIG. 2B allows for five feedings.

Block 504 initializes a Timer, which counts time to see when the desired feeding interval has been reached, and sets a JamCounter to zero, indicting that no jams have yet occurred. In block 504, the MCU 440 further increments the FeedingCounter by one.

Blocks 505 and 506 allow the MCU 440 to keep track of time until the desired time interval has passed.

In Block 507, when a feeding time has arrived, the MCU 440 sends a control signal to the driving system 450, activating the drive motor 450 to rotate the gear set 430 and to thereby initiate a clock-wise rotation of the food chamber 130.

Blocks 508-512 allow the MCU 440 to monitor the movement of the food chamber in two ways. For one, the position sensor 470 is monitored to determine if it has had a photocoupler reading indicating that the food chamber 130 is properly aligned with a next cavity 210 positioned above the chute 310. A second method of monitoring provides a backup in case the food chamber 130 has become jammed on one or more pieces of food or for some other reason. According to this method, the MCU 440 uses the JamTimer to keep track of elapsed time since the driving system last began rotating the food chamber 130. A time value in seconds, for example sixty-eight seconds, is allotted for rotation of the food chamber 130 before a timer overflow/error condition is sensed at Block 512 to set in motion jam control measures that will be described with reference to FIG. 5B.

Meanwhile, if in Block 511 the MCU 480 receives a signal that the position sensor has been triggered, indicating that the food chamber 130 is positioned to allow food to drop from a cavity 210 positioned above the chute 310 into the feeding bowl 150 below, in Block 513, the MCU 440 sends a control signal to the driving system 450 for stopping rotation.

The procedure 500 returns to Block 503, where the MCU 440 again checks if the FeedingCounter indicates that a final feeding has been made. If a final feeding has not been made, the procedure 500 continues for a next feeding, advancing through Blocks 504-513. If the MCU 440 determines that a final feeding has been made, the MCU 440 may shut down non-essential functions of the automated pet food dispenser 100 and initiate a sleep mode in which power consumption may be reduced until the user again desires to interact with the automated pet food dispenser 100.

Moving on now to FIG. 5B, if while waiting for an optical sensor message indicating proper alignment of the food chamber 130, the JamTimer indicates at Block 512 that an excessive amount of time has passed for rotation of the food chamber 130, the MCU 440 may initiate jam control procedures 520.

In Block 514, the MCU 440 increments the JamControlCounter, indicting that an additional jam has occurred. The MCU 440 next determines whether this is the sixth attempt to implement jam control procedures. According to the embodiment illustrated in FIGS. 5A and 5B, the MCU 440 is programmed to allow a maximum of five attempts at un-jamming. In the event that five attempts are not successful, the MCU 440 is programmed to cease attempting to un-jam the food chamber 130 until the next scheduled feeding time occurs.

If five attempts to un-jam the food chamber 130 have not yet been made, the MCU 440 attempts to un-jam the food chamber 130 by initiating a brief counter-clockwise rotation of the food chamber 130, followed by a return to forward rotation, as described in Blocks 516-518. Normal operation is again attempted, as indicated by a return to Block 509.

It will be understood that each of the elements described above, or two or more together, may also find a useful application in other types of constructions differing from the types described above.

While the invention has been illustrated and described as embodied in an automated pet food dispenser, however, it is not limited to the details shown, since substitutions and changes in the forms and details of the device illustrated and it s operation can be made by those skilled in the art without departing in any way from the spirit of the present invention. Accordingly, the scope of the present invention is intended to be defined only by reference to the appended claims.

1. An automated animal food dispenser, comprising:
a rotatable chamber with multiple cavities to hold food for different meals;
a removable bowl for receiving food dispensed from said chamber;
a base unit configured to support said rotatable chamber, said base unit comprising a chute with a top and a bottom that are open and that allow food from a cavity positioned above said chute to be dispensed through the chute into said removable bowl;
a rotary mechanism for rotating said rotatable chamber relative to said base unit;
a timer configured to provide an indication of a next feeding time; and
a control unit configured to receive said indication from said timer and to trigger, based at least in part on said indication, said rotary mechanism to rotate said chamber, allowing a next one of said cavities in said rotatable chamber to dispense food stored therein.

2. The automated animal food dispenser of claim 1, wherein said rotatable chamber has three cavities for holding food.

3. The automated animal food dispenser of claim 1, wherein said rotatable chamber has five cavities for holding food.

4. The automated animal food dispenser of claim 1, wherein each cavity has an opening to allow food from said cavity to drop from said cavity.

5. The automated animal food dispenser of claim 1, wherein said timer is configured to provide an indication at fixed time intervals.

6. The automated animal food dispenser of claim 1, wherein said timer may be set to provide an indication every eight, twelve, or twenty-four hours.

7. The automated animal food dispenser of claim 1, wherein said control unit, after triggering said rotary mechanism to rotate said chamber, is further configured to wait until a next timing indication from said timer.

8. The automated animal food dispenser of claim 1, further comprising a control panel affixed to said base unit.

9. The automated animal food dispenser of claim 8, wherein said control panel includes a programmable LCD clock configured to accept feeding time settings, and wherein said timer may be set to provide an indication at feeding times set using said LCD clock.

10. The automated animal food dispenser of claim 8, wherein said control panel includes a control mechanism configured to accept a desired time interval setting from a user, and wherein said timer may be set to provide an indication at feeding times set using said control mechanism.

11. The automated animal food dispenser of claim 1, further comprising a recording system for recording an audio clip and for playing said audio clip when said rotary chamber rotates.

12. The automated animal food dispenser of claim 1, further comprising a position sensor configured to sense said chamber's position, said position sensor further configured to provide an indication to said control unit when said next cavity is positioned for dispensing food; and
said control unit further configured to receive said indication from said position sensor and to trigger, based at least in part on said indication, said rotary mechanism to stop rotating.

13. The automated animal food dispenser of claim 12, wherein said control unit is further configured to receive an indication from said position sensor when said rotatable chamber stops rotating in a first direction, and wherein, if said indication signifies that said rotary chamber has stopped before a next cavity is positioned for dispensing food, said control unit is configured to cause said rotary mechanism to: (a) rotate said rotary chamber in a direction opposite to said first direction for a first fixed duration of time, (b) stop rotating for a second fixed duration of time, and (c) resume rotating said rotary chamber in said first direction.

14. The automated animal food dispenser of claim 13, wherein said first time interval is four seconds and wherein said second time interval is eight seconds.

15. The automated animal food dispenser of claim 13, wherein if, after executing steps (a), (b), and (c), said control unit receives an indication from said position sensor signifying that said rotary chamber has stopped before said next cavity is positioned for dispensing food, said control unit is configured to cause said rotary mechanism to repeat steps (a), (b), and (c).

16. The automated animal food dispenser of claim 15, wherein said control unit is further configured, while continuing to receive an indication from said position sensor signifying that said rotary chamber has stopped before said next cavity is positioned for dispensing food, to execute steps (a), (b), and (c) a fixed number of times before (c) causing said rotary mechanism to stop rotating said chamber and (d) waiting for a next indication from said timer.

17. The automated animal food dispenser of claim 1, wherein said control unit is further configured to undertake anti-jamming procedures when said rotary mechanism fails to rotate said chamber to allow said next one of said cavities in said rotatable chamber to dispense food stored therein.

18. A method of dispensing food for an animal, comprising:
outputting a timer signal;
running a motor to advance a container of food over an opening in response to receiving said timer signal; and
stopping said motor to position said container of food over said opening to permit food in said container to drop through a chute into a feeding dish for dispensing to an animal.

19. A method of feeding an animal using an automated pet feeder, said method comprising:
placing food into one or more cavities in a food chamber of an automated pet feeder;
setting a timer on said automated pet feeder to indicate feeding times;
placing a receptacle in a position for receiving said food dropped through a chute from one of said cavities; and
activating power to said automated pet feeder to cause said feeder to drop said food sequentially from said cavities into a removable bowl.

20. The method of claim 19, further comprising recording a sound recording using said automated pet feeder for playing at said feeding time.

21. A pet feeder comprising:
plural food chambers having openings which permit food to drop from said chambers;
a barrier mechanism which selectively obstructs said openings to prohibit food from dropping from said food chambers;
a guide for guiding food dropped from said food chambers; and
a timer controlling said barrier mechanism to permit food to drop from selected ones of said food chambers.

22. The pet feeder of claim 21, further comprising a feeding station which receives food that is dropped from said food chambers.

23. A system for automatically dispensing pet food, said system comprising:
plural storing means for storing quantities of pet food to be dropped at feeding times;
timing means for determining feeding times;
dispensing means responsive to said timing means for allowing pet food stored in selected ones of said storing means to drop at selected feeding times; and
guiding means for guiding dropped pet food into a feeding station.

24. The system of claim 23, further comprising anti-jamming means for correcting obstructions affecting said dispensing means.
